(19) United States
(12) Patent Application Publication
(10) Pub. No.: US 2008/0057328 A1
(43) Pub. Date: Mar. 6, 2008

(54) COATING SYSTEM FOR PIRACY-PROTECTED OPTICAL MEDIUM

(76) Inventors: Peter M. Rentzepis, Irvine, CA (US); Richard H. Selinfreund, Terre Haute, IN (US); Craig Etchegoyen, Newport Beach, CA (US); Alexander Dvornikov, Irvine, CA (US)

Correspondence Address: KELLEY DRYE & WARREN LLP, 400 ALTLANTIC STREET , 13TH FLOOR, STAMFORD, CT, 06901, US

(21) Appl. No.: 11/768,728

(22) Filed: Jun. 26, 2007

Related U.S. Application Data
(60) Provisional application No. 60/805,977, filed on Jun. 27, 2006.

(51) Int. Cl. B32B 27/28; C08F 2/46

(52) U.S. Cl. 428/500; 522/167; 522/31

(57) ABSTRACT

A piracy protection digital recording medium comprising a polymeric layer incorporating an optical state change material in conjunction with a cationic photoinitiator.

### CROSS-REFERENCE TO RELATED APPLICATIONS

This application claims benefit of U.S. Provisional Patent Application Ser. No. 60/805,977, filed Jun. 27, 2006. The disclosure of the application is hereby incorporated by reference in its entirety where appropriate for teachings of additional or alternative details, features, and/or technical background, and from which priority is asserted.

### BACKGROUND OF THE INVENTION

1. Field of the Invention

The present invention generally relates to the protection of data recorded onto recording media by application of coating system comprising a photoinitiator and a photobleach material.

2. Description of the Related Art

The development of many types of transportable optical digital storage media which contain stored digital data readable by an optical reader has burgeoned over the past thirty years. Such optical digital storage media include such well known items as compact discs, digital video discs, blue-ray discs, and optical digital memory cards. Such storage media may be passive (such as a typical CD disc) or active, such as a digital memory card containing a processor.

As data stored on such transportable digital storage media may be valuable in its own right, there has been substantial resources applied to illicitly obtaining such data from authorized digital storage media and recording such data on non-authorized digital storage media. Unfortunately, with most traditional transportable digital recording media, extraction of the data from the transportable storage media is possible anywhere in its distribution chain or at any point in which it is read. The extraction of data from such media may result in the loss of a potential sale of one or more copies of the authorized media.

As described in applicant's prior applications, optical media can be protected against piracy of data and illicit copying by application of optical state change materials to the disc in a manner to alter read of data recorded on the media when the optical state change material is in one of two or more states. Without limitation, the alteration of read may involve a change in the optical state change material form a state blocking read of data to a state allowing read of data, may entail a software and/or hardware block of read of part or all of the content on the disc unless an optical state change is discerned in or on the optical medium in a pre-determined manner encoded in the software, may entail a transient or non-transient optical change that alters the data read of the underlying data on the optical medium in whole or in part, and/or may involve computer locking software which locks the medium to a computer system upon which it is read and requires a particular optical state change material to be placed on or in the medium in a specified manner for read on such computer system.

Typical CDs and DVDs use a single layer of lacquer (“hardcoat” or “protective layer”) over the reflective data backing (on the label side) to protect against damage. Blu-ray discs which store more data per layer (e.g. 25 gigabytes v. 15 gigabytes) instead of lacquer employ a clear polymer hardcoat to provide protection from scratching and other types of damage. One such coating known as “Durabis” is available form TDK Corporation.

In preparing protective layers, there is often added a crosslinking agent to a polymer to promote crosslinking of the polymer chains. Among such crosslinking agents are photoinitiators which are compounds that under absorption of light undergo a photoreaction producing a reactive species. A photoinitiator may transform the physical energy of light into suitable chemical energy in the form of reactive intermediates. The reactive species of a photoinitiator can be used to polymerize polymerizable constituents within the coating. When polymerization is initiated with a photoinitiator and light, the process is referred to as photopolymerization or radiation curing. Thus a liquid and soluble formulation may with application of a photoinitiator turn to a hard and insoluble crosslinked polymer network. Two types of common photoinitiator classes are the radical photoinitiators and the cationic photoinitiators.

The radical photoinitiators produce radicals upon interaction with the appropriate light source. Radical photoinitiators have found particular use in the radical polymerization of acrylate and styrene formulations. Such initiators maybe activated by UV light (300-400 nm range), but radical photoinitiators activatable by wavelengths in the visible up to the IR range, or on the blue side to deep UV, are known.

Cationic photoinitiators upon activation produce either a Bronsted or Lewis acid. The are used to cationically polymerize materials, such as epoxies, and to trigger crosslinking via polycondensation reaction.

Photoinitiators used in optical media protective coating may upon activation have the unintended ability to cause pre-mature activation of optical state change materials, particularly dyes, that are not intended to change optical state until a time certain in order to effectuate the anti-piracy (by which it is meant to include “anti-copy” functionality unless specifically differentiated herein) functionality of the optical medium.

There is a need for an improved optical recording medium protective coating comprising photoinitiators and optical state change materials. There is also a need for an improved optical recording medium that reduces the ability of a photoinitiator in any protective coating applied to the optical recording medium from inadvertently activating optical state change materials in an optical recording medium, in particular when the optical state change material is designed to provide for anti-piracy protection.

### DEFINITIONS

Digital Datum Indicia: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a data read.

Digital Reader: any device capable of detecting and reading digital information that has been recorded on an Digital Recording Medium. By the term “reader” it is meant to include, without limitation, a player. Examples are CD and DVD readers.

Digital Recording Medium: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, audio files and video files.

Digitizing: Conversion of non-textual data to digital form.

Encoding: Recording electronic information.

Encryption: Transferring information based on a key to make it intelligible to unauthorized parties.

Optical State-Change Material: is a State-Change Material that alters a measurable state (e.g., without limitation, opacity, absorbance, reflectivity and/or color) upon application of a wavelength, or subwavelength, of light or application of photonic energy to the material.

Optical Medium: a medium of any geometric shape (not necessarily circular) that is capable of storing indicia or content that may be read by an optical reader.

Optical Reader: a Reader (as defined below) for the reading of Optical Medium.

Permanent State-Change Material: a State-Change Material that once activated to change a measurable state upon application of energy to the material, stays in such state permanently or for a prolonged period of time.

State-Change Material: a material capable of altering a measurable property of the material upon activation of the material by application of energy to the material. By “state change material” it is meant to include, without limitation, materials that change in optical state upon application of energy to the materials, materials that change in electromagnetic state (e.g., electroconductive state) upon application of energy to the materials, and materials that change in physical state (e.g. crystalline to non-crystalline structure) upon application of energy to the material.

Temporary State-Change Material: a State-Change Material that, once activated to change a measurable property of the material upon application of energy to the material, stays in such state for a period of time less than a year.

Transient State-Change Material: a State-Change material that, once activated to change a measurable property of the material, spontaneously in a short period of time (minutes or less), loses such change in the measurable property. It includes, without limitation, materials that move from a first state to a second state upon application of energy, and back to the first state without application of energy.

Transportable Digital Recording Medium: a relatively small medium capable of being transported by hand from one location to another that includes data readable in a digital manner. It includes, without limitation, an optical disc, a floppy disk, a flash drive.

For the purpose of the rest of the disclosure, it is understood that the terms as defined above are intended, whether such terms are in all initial cap or not.

### SUMMARY OF THE INVENTION

Embodiment disclosed herein include:

A digital recording medium comprising: a substrate having a top planar surface and a bottom planar surface, said top surface comprising a polymeric layer incorporating an optical state change material in conjunction with a cationic photoinitiator. The optical state change material may comprises at least one material selected from the group consisting of: Coumarin 30, Alizarin Red S, and porphyrin compounds. The porphyrin compounds may comprise at least one porphyrin selected from the group consisting of ocatethylporphyrin, tetrakis(o-aminophenyl)porphyrin, and magnesium octaethylporphyrin The photoinitiator is a cationic photoinitiator. The photoinitiator may be at least one of (4-methylphenyl)diphenylsulfonium triflate, tris(4-tert-butylphenyl)sulfonium perfluoro-1-butanesulfonate, (4-methoxyphenyl)diphenylsulfonium triflate, (4-methylthiophenyl)methyl phenyl sulfonium triflate, (4-bromophenyl)diphenylsulfonium triflate, or a photoactivated complement thereof.

A digital recording medium comprising: a substrate having a top planar surface and a bottom planar surface, said top surface comprising at last three layers, a layer comprising optical state change material activatable to change between at least one optical state and another optical state upon impingement with a light of appropriate wavelength; a polymeric layer comprising the reaction products of an activated photoinitiator, the photoinitiator prior to activation being capable of cross-linking polymers within the polymeric layer, and an polymeric insulating layer between the optical state change material layer and the activated photoinitiator layer, the insulating layer lacking materials capable of activating the photoinitiator or the optical state change material.

### DETAILED DESCRIPTION OF THE INVENTION

The present invention provides for a anti-piracy system on an optical medium that utilizes that state change of a state change material for effectuating the anti-piracy functionality, and a hardcoat forming system for application to the optical medium that utilizes photoinitiators in a manner that does not cause substantial unintended activation of the state change material by the photoinitiator.

In an embodiment, there is provided a digital recording medium comprising a state change material associated therewith that is associated with the medium in manner that in one state the material inhibits read of data on the digital recording medium but in another state allows read of data on the digital recording medium. The state change material may be an optical state change material wherein the state change is caused by any number of mechanisms, for example, without limitation, photobleaching. The inhibition of read may be caused by the state change physically blocking read of structure on the optical disc in its first form, but allowing read of structure on the optical disc in its second form. The inhibition of read may also be caused by software on the medium which is configured not to allow read, or complete read, of the digital recording medium unless the state change material is determined to be present on the medium in a pre-determined manner (such as, without limitation, positioned at one or more predetermined locations on the medium). Piracy protection may also be provided by software which locks the medium to a particular optical reader system utilizing the optical state change material on the medium to identify the medium as authenticated medium for read on the particular optical reader system.

The digital recording medium may be a transportable digital recording medium, and in particular an optical medium. The digital recording medium may be of the type that encodes electronic data in digital datum indicia which is readable by a digital reader. Stored digital data may be in encrypted form. Digital data may be incorporated onto the medium by the process of digitizing information. The state change material used to effectuate piracy-protection may be a permanent state-change material, a temporary state change material or a transient state-change material.

In one embodiment, the state change material is at least one optical state change material selected from the group consisting of: Coumarin 30, Alizarin Red S, and porphyrin compounds. Among the porphyrin compounds of advantageous use are zinc ocatethylporphyrin, tetrakis(o-aminophenyl)porphyrin, and magnesium octaethylporphyrin. Alizarin Red S is a Riedel-de Haen indicator.

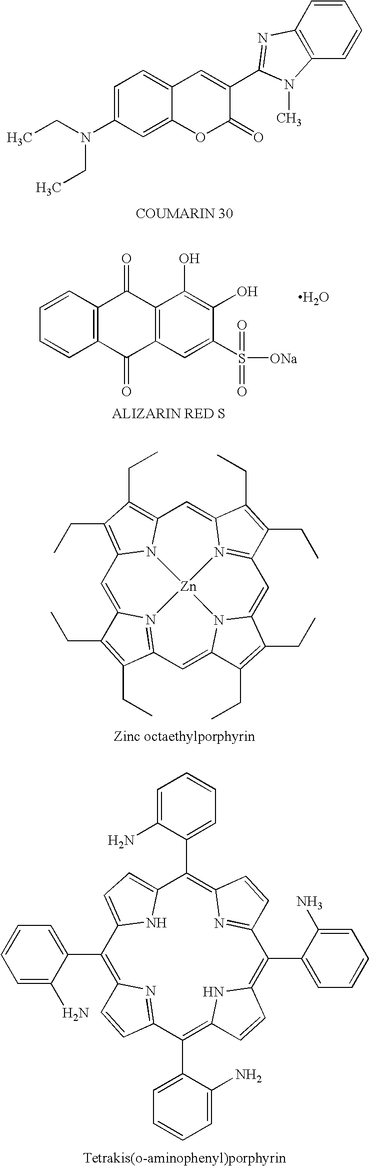

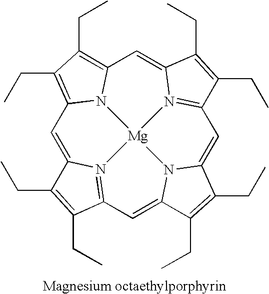

The state change material may be applied to the digital recording medium by incorporating the same into body of the digital recording medium, or may be applied to the same before, after, or concurrent with (i.e. mixed with) application of the protective coating.

In one embodiment, wherein the state change material is applied in the coating along with photoinitiator, the mechanism of action of change in state of the state change material is selected so as not to be the same mechanism of activation of the initiator. For example, the initiator and state change material may be selected such that the materials are not activated at the same wavelength of light. By avoiding the same mechanism of activation, one may prevent pre-mature activation of the state change material, such as optical state change material.

In another embodiment, wherein the state change material is applied before the protective coating, the state change material (such as optical state change material) is applied to the digital recording medium (such as optical digital recording medium) and then such material is coated with a non-activating (with respect to the state change material) insulator layer. The coat containing the initiator is then applied on the insulator layer, which by its presence protects the state change material from undergoing an undesired pre-mature state change.

In yet another embodiment, wherein the state change material is an optical state change material that absorb strongly above 300 nm, e.g. in the optical range of a CD, DVD or Blu-ray optical medium, the initiator is chosen to have small amount of absorbance above 300 nm. Cationic photoinitiators may be particularly used. The photoinitiator may be at least one of: (4-methylphenyl)diphenylsulfonium triflate, tris(4-tert-butylphenyl)sulfonium perfluoro-1-butanesulfonate, (4-methoxyphenyl) diphenylsulfonium triflate, (4-methylthiophenyl)methyl phenyl sulfonium triflate, (4-bromophenyl)diphenylsulfonium triflate, or a photoactivated complement thereof. Such photoinitiators are shown below (with attached spectrum shown):

[image]

[image]

The protective coating thickness may be adjusted so as not to reduce attenuation of light at wavelengths necessary for activation of the initiators in the protective coating and not to significantly affect the activation of the state change material necessary for effecting the anti-piracy functionality.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. A digital recording medium comprising: a substrate having a top planar surface and a bottom planar surface, said top surface comprising a polymeric layer incorporating an optical state change material in conjunction with a cationic photoinitiator.

2. The digital recording medium of claim 1 wherein the optical state change material comprises at least one material selected from the group consisting of: Coumarin 30, Alizarin Red S, and porphyrin compounds.

3. The digital recording medium of claim 2 wherein the porphyrin compounds is at least one porphyrin selected from the group consisting of: ocatethylporphyrin, tetrakis(o-aminophenyl)porphyrin, and magnesium octaethylporphyrin

4. The digital recording medium of claim 1 wherein the photoinitiator is a cationic photo initiator.

5. The digital recording medium of claim 1 wherein the photoinitiator is a at least one of: (4-methylphenyl)diphenylsulfonium triflate, tris(4-tert-butylphenyl)sulfonium perfluoro-1-butanesulfonate, (4-methoxyphenyl)diphenylsulfonium triflate, (4-methylthiophenyl)methyl phenyl sulfonium triflate, (4-bromophenyl)diphenylsulfonium triflate, or a photoactivated complement thereof.

6. A digital recording medium comprising: a substrate having a top planar surface and a bottom planar surface, said top surface comprising at last three layers, a layer comprising optical state change material activatable to change between at least one optical state and another optical state upon impingement with a light of appropriate wavelength; a polymeric layer comprising the reaction products of an activated photoinitiator, said photoinitiator prior to activation being capable of cross-linking polymers within said polymeric layer, and an polymeric insulating layer between said optical state change material layer and said activated photoinitiator layer, said insulating layer lacking materials capable of activating said photoinitiator or said optical state change material.
